(19) United States
(12) Patent Application Publication
(10) Pub. No.: US 2024/0154351 A1
(43) Pub. Date: May 9, 2024

(54) INPUT/OUTPUT DEVICE WITH INJECTION-MOLDED CABLES

(71) Applicant: Gerald LIEB, Kernen (DE)

(72) Inventor: Gerald LIEB, Kernen (DE)

(21) Appl. No.: 18/281,655

(22) PCT Filed: Apr. 13, 2022
(86) PCT No.: PCT/EP2022/059872

§ 371 Date: Sep. 12, 2023

(30) Foreign Application Priority Data
Apr. 23, 2021 (DE) 102021110465.3

(51) Int. Cl. H01R 13/50; H01R 31/02; H01R 43/18

(52) U.S. Cl. CPC H01R 13/50; H01R 43/18; H01R 31/02

(57) ABSTRACT

The invention relates to a method for producing an assembly (1) and to an assembly (1) for distributing data, comprising an input/output device (2) with at least two interfaces (11, 13) for transmitting data between participants (8, 9) connected to the interfaces (11, 13), wherein data cables (3, 4) are provided, via which the respective participant (8, 9) is connected to the interface (11, 13) corresponding to said participant at the completed input/output device (2). The invention is characterized in that a housing of the input/output device (2) is produced in a plastic injection molding method, and in the process a respective end region of the data cable (3, 4) is surrounded by the housing.

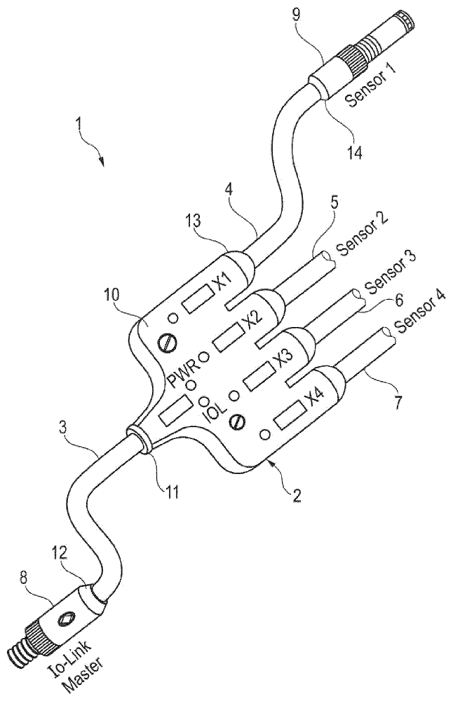

The invention relates to a module for distributing data and to a method of making such a module for distributing data according to the features of the preamble of the independent patent claims.

A module for distributing data, but no manufacturing method for such a device, is known from utility model DE 93 05 529. Its input/output device has a housing on which are provided plug-in connections or ports into which plug-in connectors can optionally be inserted (and also pulled out again). These plug connectors are each connected to a data cable whose other end is connected to a user, such as for example a sensor, an actuator or the like. One of the users is designed to connect the device to a superordinate controller and data is sent (distributed) to the other users (such as, for example, the mentioned sensors or actuators) via the input/output device.

In this prior art, the plug connectors connected to the ports of the input/output device are designed as plug-in screw connections. Although such a design has proven successful in practice, in particular with regard to the reliability of this connection and also the tightness thereof, it is disadvantageous that a multiplicity of parts (such as devices, data cables, plug-in connectors, users) must be made separately from one another and later assembled separately in the field.

Because of the multiplicity of elements of the device that have to be connected in the field, it is not always possible to ensure that assembly is carried out satisfactorily, so that for example mounting of the plug-in screw connection as a result of a skewed plugging does not take place properly, and therefore transmission difficulties and also seal problems can occur.

The object of the invention is therefore to improve a generic device and avoid the disadvantages described above.

The invention also relates to a method of making such a device.

These objects are attained by the features of the independent patent claims.

With regard to the module for distributing data, according to a first variant, according to the invention it comprises a housing of the input/output device injection molded of a plastic surrounding the end of the data cable. This means that manufacture of the housing of the input/output device entails injection molding plastic into its interior to in particular protect the sensitive electrical and electronic components of the input/output device in the field while also surrounding the end of at least one data cable, so that a connection that is resistant to media and resistant to mechanical stresses is realized there. Thus, on the one hand, the disadvantage the complex plug-in screw connections and their faulty assembly and leaks are avoided. The length of the overmolded area of the data cable, in particular its outer jacket, is selected such that, on the one hand, longitudinal water tightness is realized, but on the other hand mechanical loads, such as tensile and compressive stresses, as well as buckling movements, are also resisted.

In a second variant, it is provided according to the invention that a casing of the input/output device is made of metal and that an interior of the casing is cast with a plastic that extends over at least the respective end of the data cable. The use of metal for the casing has the advantage that it shields the interior, so that further shielding measures can be dispensed with. For this purpose, the shielding of the respective data cable is directly or indirectly (for example via connecting means such as cable, springs or the like) electrically contacted with the metal casing.

A metal casing (for example made by die casting) could also be considered, which is encapsulated by overmolding with plastic and this encapsulation also surrounds the ends of the cable connected to the housing and the encapsulation can even extend as far as the connected sensors/actuators. This means that the second shell (housing) is formed around the metal casing by an injection process in order to improve haptics, for design reasons, but also for functional reasons. In particular, IP protection is achieved by the overmolding of plastic. In the case of very short connected data cables, instead of the complete cable, only strands could also be used, which is then passed to the sensor system via a type of antikink sleeve. Moreover, the advantages listed above with respect to the first variant also remain in this second variant. Potting the interior of the metal casing (analogous to the further variant described below) is also conceivable here.

In a further variant, it is provided according to the invention that a casing of the input/output device is made of plastic and that an interior of the casing is potted by injection molding with a plastic that extends over at least the respective end of the data cable. A liquid medium is introduced into the interior (cavity) and cures there. The cavity can be completely potted or else only partially potted. Potting (or also referred to as casting) of the interior has the advantage that it effectively protects against external influences such as dust, moisture, liquid and the like. Moreover, the advantages listed above with respect to the first and/or second variant also remain in this further variant.

It is also conceivable to provide a casing made of plastic (for example by plastic injection or another method), and thereafter this plastic casing and the cable connected to it are overmolded by injection molding with plastic. A 2-component injection molding method can make a casing for example from a suitable hard plastic, and the sealing at the housing ports for the cable is realized simultaneously with a softer plastic.

In principle, the same plastic would be used for the housing as for the outer jacket surrounding the cable. Alternatively, it may also be different plastics, which are processed in a 2-component injection process. For good sealing, it is always advantageous if the plastic has the same material properties as the cable sheath. However, there are also other criteria such as media resistances, flammability, smoke generation or transparency that require a different plastic as in the case of the cable. Cables must in particular be abrasion-resistant and flexible, so that it is quite useful to employ different materials via a 2-component injection process.

In a further development of the invention, it is provided that a housing of at least one of the users is injection-molded onto an end of its respective data cable. While in the prior art the users, such as, for example, the already mentioned sensors, actuators or the like, are also connected via plug-in connections, such as the already mentioned plug-in screw connections, the advantage is also utilized here that a housing of the user is made in a plastic injection-molding process and in this case an end of the respective user is also made in a plastic injection-molding process so the data cable is encapsulated by injection molding. This also gives longitudinal water tightness, and reduces the number of elements to be connected together in the field and consequent malfunctions, such as, for example, slewed and thus poorly connecting and unsealed plug-in screw connections are eliminated.

It has hitherto been assumed that at least one of a plurality of data cables with its respective end is surrounded by the housing of the input/output device and optionally at least one end of a data cable on a housing of at least one user is injection-molded. This means that it is not excluded, in the case of the input/output device, to provide ports to which plug connectors can be inserted, as is carried out, for example, in the prior art described above.

In order to optimize the tightness of the entire device and to reduce the number of elements to be mounted in the field, according to the invention all data cables are surrounded by the housing of the input/output device and the housings of all the users are injection-molded onto the end of their respective data cable. This results in a self-contained device which is sealed very tightly with respect to external influences. In addition, it is possible, after previous measurement of the site of use of the device with regard to the placement of the input/output device and also with regard to the length of the data cables between the input/output device and the device of the respective users, to make an individually designed module for distributing data.

The above-described variants of the devices for distributing data can be made by the method according to the invention of making such a device.

Plastic injection molding methods are generally known in which the participating elements are inserted into a plastic injection mold and then surrounded by a plastic.

According to the production method according to the invention, this means that the elements (such as, for example, printed circuit board with electrical and electronic components arranged thereon) and the end located in the interior of the input/output device of a data cable to be surrounded in each case with plastic of the housing is inserted into the injection mold, and these regions are then encapsulated with plastic.

Alternatively, it is conceivable that the housing of the input/output device is initially made without its internal elements and wherein the ends of the respective data cable, preferably the ends of all data cables, are made by injection-molding. If this is done, the electronics can be inserted into the interior of the, for example, two-part or multi-part housings and can be electrically connected to the data cables. The same also applies to the case in which not only the ends of a respective or all data cables are encapsulated by the housing of the input/output device, but that at least one housing of a user is also sufficiently injection-molded over the end of its data cable to which the user is connected.

An embodiment of a device according to the invention comprising an input/output device is described below and explained with reference to a single FIG.

A module 1, insofar as shown in detail, is an input/output device 2. This device 2 has a housing connected to at least two data cables 3, 4. The one data cable 3 connects the device 2 to a higher-level controller (not shown) and the data cable 4 to a user so that data can be exchanged between the higher-level controller via the device 2 and the at least one user. Such an input/output device 2 is basically known and is also referred to as a distribution module, IO hub or IO device (I: Input, O: Output). In addition, reference is made to above-mentioned DE 93 05 529 Ul, for example, for the basic design and mode of operation of such a device.

In the embodiment in the single FIGURE, further data cables 5 to 7 go from the housing of the device 2 in addition to the data cables 3, 4. A first user 8 is connected to the data cable 3 and a user 9 is connected to the data cable 4. Of course, further users are connected to the further data cables 5 to 7, but this is not shown for the sake of simplicity.

In principle, a user can be a plug connector, a sensor, an actuator or the like. In the embodiment according to the FIGURE, the user 8 is designed as a plug-in connector, via which the module 1 can be detachably connected to the (unillustrated) superordinate controller.

According to the invention, the housing 10 of the device 2 extends out beyond the end of the data cable 3 in the region of a port 11 where the data cable 3 leaves the housing 10, more precisely the outer sheath thereof, in the plastic injection-molding process, so that there is a media-tight and nondetachable connection between the data cable 3 and the housing 10 of the device 2 in the region of the port 11.

Such an integral and nondetachable connection can also be realized in the region of a port 12 where the other end of the data cable 3 is inserted into the housing of the user 8.

Such a media-tight and nondetachable connection can also be realized in the region of a port 13, where one end of the data cable 4 leaves the housing 10 of the device 2. The same can also apply to the ports in which the data cables 5 and/or 6 and/or 7 and/or more or fewer data cables leave the housing 10 of the device 2.

As already in the case of the user 8, the end of the data cable 4 that enters the housing of the user 9 can be located at the user 9 in the region of a port 14 where there can be a media-tight and nondetachably encapsulated connection.

In a particularly advantageous manner, all the ports 11, 12, 13 and the further ports at the two ends of the respective data cables 5 to 7 are realized in a media-tight and nondetachable manner by encapsulation. In a particularly advantageous manner, all the ports 11, 12, 13 and the further ports at the two ends of the respective data cables 5 to 7 are realized in a media-tight and nondetachable manner by encapsulation.

Of course, not all of these ports need to be realized in a media-tight and nondetachable manner by extrusion coating with plastic, but it is also possible to use a part of the ports as is known in the prior art as a plug-in connection, for example as a screw plug connection.

LIST OF REFERENCE NUMERALS

| | |
|---|---|
| 1 | Device |
| 2 | Input-output device |
| 3 | Data cable |
| 4 | Data cable |
| 5 | Data cable |
| 6 | Data cable |
| 7 | Data cable |
| 8 | User |
| 9 | User |
| 10 | Housing |
| 11 | Port |
| 12 | Port |
| 13 | Port |
| 14 | Port |

1. A module for distributing data, comprising:
an input/output device with at least two ports for transmitting data between users connected to the ports and respective data cables connecting each of the users to the respective port, the input/output device has having a housing made by injection molding of a mass of plastic surrounding the end of at least one of the data cables.

2. The module defined in claim 1, further comprising:
a casing of the input/output device is made of metal and
a mass of injection-molded plastic that is in an interior of the casing and extends over at least the respective end of the data cable.

3. The module defined in claim 1, further comprising:
a casing made of a hard plastic and
a mass of injection molded plastic that fills an interior of the casing and extends over at least the respective end of the data cable.

4. The module according to claim 1, wherein a housing of at least one of the users is injection-molded onto an end of the respective data cable.

5. The module according to claim 1, wherein all data cables are surrounded by the housing of the input/output device and the housings of all the users are injection-molded onto ends of their respective data cable.

6. A method of making a module for distributing data, comprising the steps of:
providing an input/output device with at least two ports for transmitting data between users connected to the ports and respective data cables connecting the users to the respective ports in the input/output device when ready to use; and
injection molding a housing of the input/output device with a plastic that surrounds a respective end of the data cable.

7-8. (canceled)

9. The method according to claim 6, wherein a housing of at least one of the users is injection-molded onto an end of its respective data cable.

10. The method according to claim 6, wherein the housings of all the users are injection-molded onto the ends of their respective data cables.

11. A method of making a module for distributing data, comprising the steps of:
providing an input/output device with at least two ports for transmitting data between users connected to the ports and respective data cables connecting the users to the respective ports in the input/output device; and
injection molding a housing of the input/output device with a plastic that surrounds a respective end of the data cable.

12. The method of making a module for distributing data according to claim 11, further comprising the step of:
injection molding and thereby potting a casing of metal with a plastic forming a housing of the input/output device and surrounding a respective end of the data cable.

13. The method of making a module for distributing data according to claim 11, further comprising the step of:
injection molding and thereby potting a casing of plastic with a plastic forming a housing of the input/output device and surrounding a respective end of the data cable.

14. The method of making a module for distributing data according to claim 13, wherein the plastic of the casing is harder than the plastic of the housing.
